(19) United States
(12) Patent Application Publication
(10) Pub. No.: US 2016/0335839 A1
(43) Pub. Date: Nov. 17, 2016

(54) Method and System for Game Show Themed Dual Component Lottery Game

(71) Applicant: Scientific Games International, Inc., Newark, DE (US)

(72) Inventors: Stephen Kyle Rogers, Cumming, GA (US); Victor Marinelli, Cumming, GA (US); Charles Boykin, Alpharetta, GA (US); Charles Holton, Alpharetta, GA (US)

(21) Appl. No.: 15/218,789

(22) Filed: Jul. 25, 2016

Related U.S. Application Data
(63) Continuation of application No. 12/240,135, filed on Sep. 29, 2008.
(60) Provisional application No. 60/977,195, filed on Oct. 3, 2007.

(51) Int. Cl. G07F 17/32

(52) U.S. Cl. CPC G07F 17/329; G07F 17/3244; G07F 17/3255; G07F 17/3225

(57) ABSTRACT

A method and system for conducting a terminal based lottery game having an instant game component and raffle component includes point of sale terminals where paying players are issued a game ticket having an instant lottery game play. A randomly generated raffle number is assigned to each game ticket, with all assigned raffle numbers being eligible to win in a subsequent raffle drawing. The raffle drawing is conducted in conjunction with an independent third party event, such as a televised game show, wherein the raffle prize is a function of a prize awarded in the event independent of the lottery game.

### RELATED APPLICATION

The present application is a Continuation Application of U.S. patent application Ser. No. 12/240,135, filed Sep. 29, 2008, which claims priority to U.S. Provisional Application Ser. No. 60/977,195, filed Oct. 3, 2007.

### FIELD OF THE INVENTION

The present invention relates to a lottery game having an instant game component and a raffle component, wherein the raffle component is played in conjunction with an independent third party event.

### BACKGROUND OF THE INVENTION

Various examples of instant lottery games are well known wherein players purchase game related tickets at a remote point of sale, such as a retail establishment. The tickets may be, for example, scratch-off tickets related to any number of themed games. For example, the games may relate to professional sports teams or organizations, game shows, and the like. The games are typically sanctioned or licensed by the organizations that own the various intellectual property rights associated with the games, logos, trademarks, and so forth. NASCAR® licensed instant lottery games are a well known example of a sponsored or licensed game. Such games have wide appeal to the avid fans and supporters of the organization, and may be preferred by retailers and lottery promoters for this reason alone.

Instant lottery games licensed by and based on popular television game shows have also gained popularity in recent years. For example, the Ohio State lottery offers an instant lottery based on the popular The Price is Right™ game show. A number of different Wheel of Fortune™ themed instant lottery games are also well known. The affinity of game show viewers for instant lottery tickets based on the respective game shows is widely recognized in the lottery industry.

Regardless of the affiliated game show or other licensed organizational theme, the instant lottery games are conducted in a typical scratch-off card format wherein players purchase instant scratch-off cards with the game data (winning or losing event) revealed upon the player scratching or otherwise removing an opaque layer from the play area. The award is established, printed on the cards, and instantly known to the player. Other than the affiliated indicia on the game card, there is essentially no other correlation or activity between the game and the licensing organization.

The lottery gaming authorities (i.e., state or local municipalities) and ticket manufacturers benefit from the affiliation with the game shows and other licensing organizations due to increased popularity of the games, and thus increased ticket sales. In return, the licensing organizations receive a commensurate license fee. The lottery game, however, does not necessarily promote increased participation in their organization. In other words, the organization (i.e., NASCAR® or Wheel of Fortune™) promotes participation in the lottery, but the lottery does not necessarily promote increased participation or fan support in the organization.

The present invention relates to a unique lottery game that benefits from affiliation with a popular third party licensing organization, and also promotes participation in the organization by lottery players.

### SUMMARY OF THE INVENTION

Objects and advantages of the invention will be set forth in part in the following description, or may be obvious from the description, or may be learned through practice of the invention.

In accordance with aspects of the invention, a method and system for conducting a terminal-based lottery game are provided. The lottery game includes an instant game component and a raffle component. A plurality of point-of-sale terminals are used to issue paying players a game ticket having an instant lottery game play. These point-of-sale terminals may be at any desired location, and are typically at various retail establishments such as convenience stores, grocery stores, gas stations, and so forth. The plurality of remote terminals are networked with a central gaming authority control computer. It should be appreciated that the central “gaming authority” may be any entity that administers or is responsible for administration of the lottery game, and may be, for example, a state or other municipal authority, a gaming organization, and so forth.

In certain embodiments of the lottery game, play is initiated by a player completing a game slip wherein a set of characters, such as numbers, are designated by the player from a group of characters presented on the game slip. For example, the player may be asked to designate a set of four numbers from a grouping of numbers 1 through 20. In an alternative embodiment, the player may be provided with the option to select a “quick-play” option wherein the four numbers are randomly generated for the player by the terminal. The game slip is completed at the terminal by the player, and then scanned at the terminal. A game ticket is then issued to the player reflecting the player's selection of numbers or characters, or the random set generated by the terminal. The game ticket also reflects whether the numbers or characters selected by the player, or randomly generated for the player, constitute a winning ticket, as explained in greater detail below.

With each generated game ticket, a raffle number is assigned to the ticket to be used in a subsequent raffle drawing. The raffle drawing includes all assigned raffle numbers issued for a given time period prior to the raffle. In this way, a winner is guaranteed in the raffle drawing.

The raffle is conducted in conjunction with an independent third party event. This third party event may be any event that is unrestrained by the lottery and that awards a prize that is independent of the lottery. A typical third party event may be, for example, a contest or game wherein contestants compete for an award. The lottery raffle prize is a function of the winning contestant's award. For example, the raffle prize may have a value equivalent to the value of the contestant's award, or may have an increased value based on a multiplication of the winning contestant's award.

The lottery ticket thus purchased by players at the remote terminals has an instant game component played at the terminal and a subsequent raffle component played at a later time or date. This multiple-component game will have appeal to many lottery players.

In a unique embodiment of the method and system according to the invention, the independent third party event is a televised game show. Game shows such as the Wheel of Fortune™ or The Price is Right™ have a vast following of viewers, and lottery games affiliated with or licensed by the game shows will have great appeal to these viewers. In this regard, the instant lottery game component may have a theme based on the game show, and the raffle component prize is based on the winnings of the game show contestant. The raffle drawing can be conducted in conjunction with the game show, and may be, for example, televised during or immediately after the game show. Alternatively, the raffle may be conducted by the gaming authority at a later time. The lottery ticket will instruct the players as to the particular date and time of the game show that determines the raffle prize, and may also provide the time and date of the raffle drawing. With this unique interaction between the lottery game and the game show, the game show is also promoted via the lottery game in that lottery ticket purchasers are encouraged to view the televised game shows.

With many known televised game shows, the prize awarded to the winning contestant may be any combination of cash, merchandise, or other items. In this event, the raffle prize may have a cash value that is at least equivalent to the value of the prize or prizes won by the game show contestant.

In a particularly desired embodiment, the lottery game is based on the Wheel of Fortune™ game show. In this embodiment, play of the instant lottery game is initiated by a paying player submitting a game slip that designates a set of characters that correspond to positions around a game wheel depicted on the game ticket. Alternatively, the player may select the quick-play option wherein the set of characters is randomly generated for the player. Each position on the game wheel has a designated value, and a winning event occurs when at least two of the player's selected positions (or randomly generated positions) have the same value, with the player winning this value. For each generated ticket, the position of the characters (i.e., numbers) around the wheel is randomly generated by the terminal. In an alternative embodiment, the position of the characters may remain the same for each ticket, with the value of the individual wheel positions randomly changing for each game ticket.

The game ticket thus instantly provides to the player an indication as to whether a prize has been won in the instant game component. A separate designated part of the ticket also provides the player with the randomly generated raffle number and with instructions as to the time of the game show in which the raffle will be concluded.

It should be appreciated that the game and system in accordance with the present invention may require some degree of coordination and cooperation between the gaming authority and the producers/owners or affiliates of the independent third party event, particularly televised game shows. Affiliate and licensing agreements may be necessitated, as well as coordination of the raffle component. For example, the gaming authority may coordinate with the show producers, or local affiliates that air the game show, to draw the winning raffle at the end or during an intermission of the last broadcast of the show in a particular state or region.

It should be readily appreciated that various other independent third party events may serve as the basis for the raffle component of the lottery game in accordance with the invention. The raffle prize is tied to or based on an award made in the third party event, but in no way dictates or influences the event.

Aspects of the invention will be described in greater detail below by reference to particular embodiments illustrated in the figures.

### BRIEF DESCRIPTION OF THE DRAWINGS

FIG. 1 is a perspective view of a game slip that may be used by a player to initiate play of an embodiment of a lottery game in accordance with aspects of the invention.

FIG. 2 is a perspective view of a lottery ticket that may be used in play of an embodiment of a lottery game in accordance with aspects of the invention.

FIG. 3 is a diagrammatic flow chart illustrating processes of an embodiment of a lottery game in accordance with the invention.

FIG. 4 is a basic block diagram illustrating conceptual aspects of an embodiment of a lottery game according to the invention.

### DETAILED DESCRIPTION

Reference will now be made in detail to embodiments of the method and system according to the invention, particular examples of which are illustrated in the drawings. Each embodiment is provided by way of explanation of the invention, and not meant as a limitation of the invention. For example, features illustrated or described with respect to one embodiment may be used with another embodiment to yield still a further embodiment. It is intended that the invention include these and other modifications and variations to the embodiments illustrated and described herein as come within the scope and spirit of the invention.

The figures illustrate a particular embodiment of a method and system for conducting a dual component lottery game as discussed above wherein the independent third party event is a televised game show, in particular the Wheel of Fortune™. It should be appreciated that this embodiment is for illustrative purposes only, and that the independent third party event may encompass any event wherein an award or prize is designated independent from involvement or influence from the lottery game.

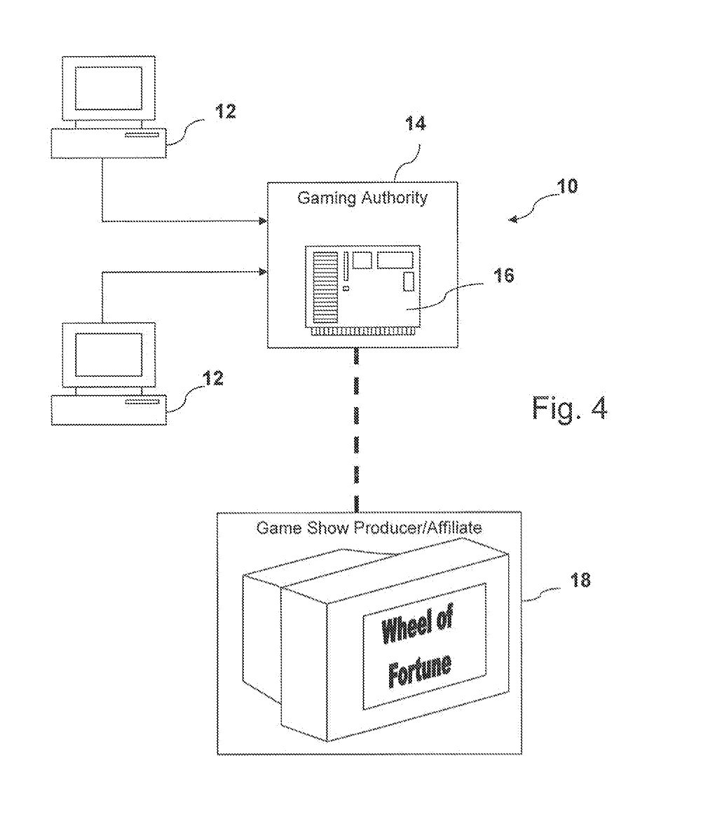

Referring to FIG. 4 for basic conceptual aspects of a system and methodology 10 for a terminal-based lottery game in accordance with the invention, a plurality of remote lottery terminals 12 are provided at any convenient establishment, such as retail locations, and so forth. The terminals 12 are networked with a computer 16 of a central gaming authority 14. As mentioned, this gaming authority 14 may be the state or municipal game administrator, or other lottery organization. The networking of a plurality of remote lottery ticket terminals 12 with a central gaming authority 14 is well known and understood by those skilled in the art, and a detailed explanation of the configuration and advantages of such a system are not necessary for the present disclosure.

FIG. 4 also illustrates a game show producer/affiliate 18. As will be described in greater detail below, the relationship between the lottery game and the independent third party event (in this case the televised game show Wheel of Fortune™) is depicted by the dashed line in FIG. 4. Aspects of this relationship are described herein.

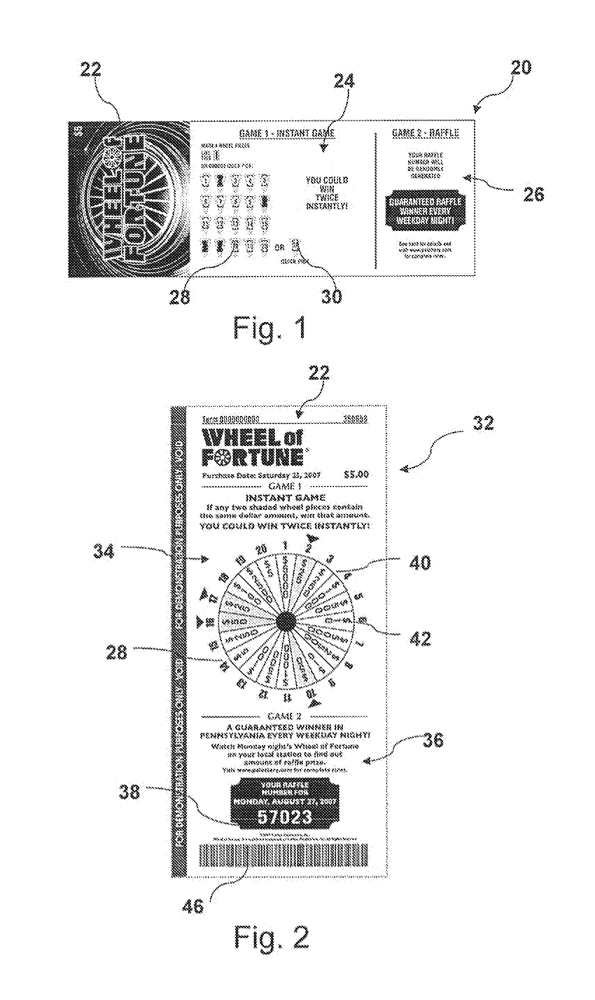

Referring to FIGS. 1 and 2, the dual component lottery game is initiated at the terminal locations by paying players completing a game slip 20. Referring to FIG. 1, the game slip 20 includes any manner of indicia 22 that identifies the game with the affiliated/licensed game show. The game slip 20 includes at least two distinct regions related to the components of the lottery game. Area 24 is the player's selection area for the instant lottery game, and area 26 relates to the raffle component of the game. In area 24, the player is asked to select a set of characters or numbers 28 from a grouping. For example, in the illustrated embodiment, numbers 1 through 20 are presented and the player is asked to select four numbers. Alternatively, the player may select the quick-play option 30 wherein the set of four numbers will be randomly selected by the terminal for the player.

The raffle area 26 informs the player of the existence of the raffle component of the game, and that the player's unique raffle number will be randomly generated.

At the terminal location, the game slip 20 is scanned and a game ticket 32 (FIG. 2) is generated. The game ticket 32 includes the same or different indicia 22 related to the affiliated game show, as well as an instant game play area 34, and a raffle area 36. The instant game play area 34 presents the results of the instant lottery game to the player. Preferably, the instant lottery game is themed or based on some aspect of the affiliate game show. For example, in the illustrated embodiment, a wheel 40 is depicted. This wheel 40 is widely recognized as symbolic of the Wheel of Fortune™ television game. The wheel 40 includes distinct positions 42, with each position 42 having a cash value designated therein. The group of characters or numbers presented on the game slip 24 are located around the wheel, with each number associated with a given wheel position 42. The game ticket 24 visibly indicates the set of numbers either selected by the player via the game slip, or randomly generated for the player. For example, in the illustrated embodiment, the player selected numbers 2, 10, 16, and 17 via the game slip 20. These selections are indicated on the game ticket 32 by arrows and by corresponding shading of the associated wheel positions 42. Players can readily determine whether they have won by simply examining the shaded or marked wheel positions 42. If any two shaded or marked wheel positions 42 contain the same dollar amount, the player wins that dollar amount. For example, in the illustrated embodiment, $25.00 appears in two of the four shaded wheel positions 42. Thus, the player wins $25.00. Because four positions are selected by the player, it is possible that the player can win twice in the instant game lottery component. For example, in the game ticket 32 shown in FIG. 2, positions 16 and 10 indicate $50.00. Thus, the player wins $50.00 in addition to the $25.00 indicated by positions 2 and 17, for a total of $75.00.

For each game ticket 32 generated, the relative location of the characters 28 around the wheel 40 may be randomly generated by the terminal for each ticket. However, in an alternate embodiment, the characters may remain constant for each ticket, with the value of the wheel positions being randomly generated for each game ticket. In still another embodiment, both the position of the characters around the wheel, and the individual value positions of the wheel may be randomly generated.

The raffle area portion 36 of the game ticket 32 provides to the player a unique raffle number randomly generated at the terminal. These raffle numbers are communicated to the central gaming authority 14, and all of (and only) the assigned raffle numbers are entered into a subsequent drawing. Thus, because only assigned numbers are in the pool of raffle numbers, a winner is guaranteed for each drawing. The area 36 in the ticket indicates to the player the time of the game show that will determine the raffle prize, and any other information related to the raffle drawing.

It should be understood that the raffle drawing may be conducted as a portion of the show by the show producer, or incorporated in broadcasting of the show by a local affiliate. For example, the local affiliate may coordinate with the gaming authority 14 to draw the raffle number during an intermission in the show, or immediately after the show. In still an alternative embodiment, the gaming authority 14 may conduct the raffle drawing at a later time independent of the show time.

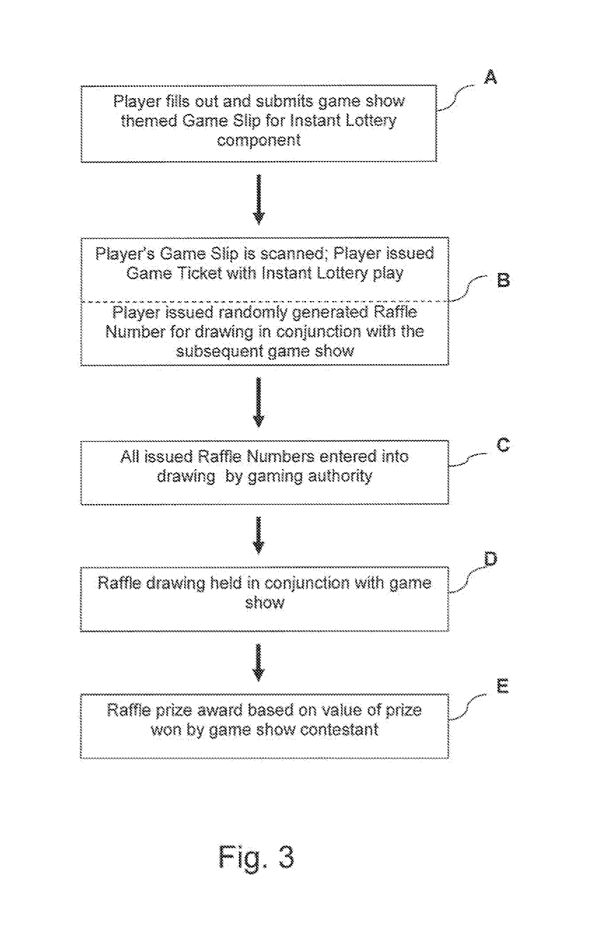

The raffle prize is based upon the prize awarded to a contestant in the game show. For example, the contestant may win $12,000.00 in cash and a car worth $28,000.00 in a particular game show. In this event, the lottery raffle winner may be awarded $40,000.00 (equal in value to the combined game show prizes). The raffle prize may be equal in value to the game show prize, or may be increased or decreased by a factor stated on the lottery game ticket 32. FIG. 3 illustrates a basic flow chart diagram illustrating certain concepts of a system and methodology according to the invention. In step A, a player fills out and submits a game show themed game slip for the instant lottery component of the lottery game. At step B, the game slip is scanned at a remote terminal and the player is issued a game ticket with the instant lottery play. The player is also issued a randomly generated raffle number for a drawing in conjunction with the subsequent game show. This raffle number may be presented with the game ticket (as indicated by the dashed line in block B), or may be separately issued, but preferably at the same time.

In step C, all of the issued raffle numbers are entered into the raffle drawing by the gaming authority. In this manner, a guaranteed winner will result from the raffle.

In step D, the raffle drawing is held in conjunction with the game show. As mentioned, the raffle may be concluded during or after the game show, and may be conducted as an active segment of the show, or conducted completely independent of the show by the gaming authority.

In step E, the raffle prize award is based on the value of the prize won by the game show contestant. In this way, the raffle winner is not aware of their prize until after conclusion of the game show, even if the raffle number is drawn before or during the game show.

It should be readily appreciated by those skilled in the art that various modifications and variations can be made to the lottery game system and methodology described herein without departing from the scope and spirit of the invention. For example, the independent third party event may be a game show wherein an affiliation exists between the lottery game and the game show. In alternative embodiments, the third party event may be any event or organization wherein a prize or award is not established until after conclusion of the event. This event may be a sporting event, game of skill, game of chance, and so forth. The event is used to provide an unknown raffle award such that the lottery game raffle players are not aware of their potential prize until conclusion of the third party event. This unique relationship will generate interest in the third party event and a degree of excitement for the lottery players.

What is claimed is:

1. A computer-implemented method of conducting a terminal-based lottery game having an instant game component for play of an instant lottery game and a raffle component, the method comprising:
at terminal point of sale locations networked with a gaming authority central computer, scanning, via one or more terminal scanners, game slips provided by players;
at the terminal point of sale locations, generating, via one or more terminals, game tickets based on the game slips for the players to purchase, the game tickets having an instant lottery game play;
assigning, via the terminal, a randomly generated raffle number to each game ticket and communicating the randomly generated raffle numbers to the gaming authority central computer, with all assigned raffle numbers being entered into a subsequent raffle drawing, wherein at least one of the assigned raffle numbers is drawn as a winning raffle number from all of the entered raffle numbers; and
the gaming authority central computer communicating with an independent third party event so as to conduct the subsequent raffle drawing in conjunction with the independent third party event, wherein a raffle prize awarded in the subsequent raffle drawing is a function of a prize awarded in the independent third party event independent of the instant lottery game.

2. The method as in claim 1, wherein the independent third party event includes contestants, with at least one contestant winning the prize, the raffle prize based on a value of the prize won by the at least one contestant such that a value of the raffle prize is not known to the lottery game players until conclusion of the independent third party event.

3. The method as in claim 2, wherein the independent third party event is a televised game show, the instant lottery game having a theme based on the televised game show and the raffle prize based on the prize won by the at least one contestant.

4. The method as in claim 3, wherein the subsequent raffle drawing is conducted in conjunction with the televised game show and televised with the televised game show.

5. The method as in claim 3, wherein the raffle prize has a cash value at least equivalent to the value of the prize won by the at least one contestant.

6. The method as in claim 1, wherein to play the instant lottery game, the lottery game players submit a game slip designating a set of characters or designating acceptance of a randomly generated set of characters, the characters corresponding to positions around a game wheel depicted on the game ticket, with each position having a designated value, wherein winning plays of the instant lottery game are determined by matching the designated values on any two of the positions around the game wheel.

7. The method as in claim 6, wherein positions of the characters around the game wheel is randomly generated for each game ticket.

8. The method as in claim 6, wherein the designated value of the positions around the game wheel is randomly generated for each game ticket.

9. A terminal based lottery game system for conducting a lottery having an instant game component for play of an instant lottery game and a raffle component, said system comprising:
a plurality of point of sale terminals networked with a central gaming authority, each of the terminals comprising a scanner configured to scan a game slip provided by a player;
game tickets generated by the plurality of point of sale terminals based on the game slips for the player to purchase, each of said game tickets having an instant lottery game play;
each of said game ticket having a randomly generated raffle number assigned thereto, with all assigned raffle numbers automatically entered into a subsequent raffle drawing wherein at least one of said assigned raffle numbers is drawn as a winning raffle number from all of said assigned raffle numbers; and
said subsequent raffle drawing conducted in conjunction with an independent third party event wherein a raffle prize awarded in said subsequent raffle drawing is a function of a prize awarded in the independent third party event.

10. The system as in claim 9, wherein the independent third party event includes contestants, with at least one contestant winning a prize, the raffle prize based on a value of the prize won by the at least one contestant such that a value of the raffle prize is not known to the player until conclusion of the independent third party event.

11. The system as in claim 10, wherein the independent third party event is a televised game show, said instant lottery game play having a theme based on the televised game show, the raffle prize based on the prize won by the at least one contestant.

12. The system as in claim 11, wherein said instant lottery game play comprises a game wheel depicted on said game tickets, with positions around said game wheel having a designated value, each said position having a character assigned thereto, said game tickets indicating a set of said characters selected by the player or randomly generated for the player wherein winning plays of said instant lottery game are determined by matching the designated values on any two of said positions around said game wheel.

13. The system as in claim 12, wherein the positions of said characters around said game wheel is randomly generated for each of said game tickets.

14. The system as in claim 12, wherein the designated value of said positions around the game wheel is randomly generated for each of said game tickets.
